(19) United States
(12) Patent Application Publication
(10) Pub. No.: US 2026/0196396 A1
(43) Pub. Date: Jul. 9, 2026

(54) Bobbin Structure and Electromagnetic Coil

(71) Applicant: ZHEJIANG DUNAN ARTIFICIAL ENVIRONMENT CO., LTD., Shaoxing, Zhejiang (CN)

(72) Inventors: Wangping RU, Shaoxing, Zhejiang (CN); Bin WEI, Shaoxing, Zhejiang (CN); Changjun XIAO, Shaoxing, Zhejiang (CN)

(21) Appl. No.: 18/854,055

(22) PCT Filed: Mar. 28, 2023
(86) PCT No.: PCT/CN2023/084494

§ 371 Date: Oct. 3, 2024

(30) Foreign Application Priority Data
Apr. 7, 2022 (CN) 202210362024.6

(51) Int. Cl. H01F 5/02

(52) U.S. Cl. CPC H01F 5/02

(57) ABSTRACT

Some embodiments of the present disclosure provide a bobbin structure and an electromagnetic coil. The bobbin structure includes a first bobbin section. The first bobbin section includes first mounting protrusions and a mounting recess, the first mounting protrusions are located in the mounting recess, and the first mounting protrusions are configured to support a grounding tab. The first bobbin section further includes a first recess. The mounting recess is formed in a bottom wall of the first recess, so that plastic material flows from the first recess to the mounting recess for plastic sealing. The present disclosure solves the problem in the related art of poor insulation performance of the electromagnetic coil.

### CROSS-REFERENCE TO RELATED DISCLOSURE

The present disclosure is a national stage application of International Patent Application No. PCT/CN2023/084494, which is filed on Mar. 28, 2023, and claims priority to Chinese Patent Application No. 202210362024.6, filed on Apr. 7, 2022, and entitled “Bobbin Structure and Electromagnetic Coil”, the contents of which are hereby incorporated by reference in its entirety.

### TECHNICAL FIELD

The disclosure relates to a technical field of electromagnetic coils, and specifically relates to a bobbin structure and an electromagnetic coil.

### BACKGROUND

For an electromagnetic coil, insulation performance is the most basic and most critical safety performance indicator. At present, the overall wall thickness of the part of a structure where a grounding plug of the electromagnetic coil and a bobbin are mounted is less than the other ⅔ of a platform of a jaw-shaped part, and the injection molding amount is small, which easily makes the insulation performance of the electromagnetic coil not good enough and causes the breakdown phenomenon, thereby resulting in poor encapsulation effect of a plastic sealing encapsulation layer.

In addition, the existing bobbin is easily separated from a magnetic conductive frame, which may also cause the problem of poor insulation performance of the electromagnetic coil.

### SUMMARY

Some embodiments of the present disclosure provide a bobbin structure and an electromagnetic coil to solve the problem in the art known to inventors of poor insulation performance of the electromagnetic coil.

In order to achieve the above objective, according to one aspect of the present disclosure, a bobbin structure is provided, including a first bobbin section. The first bobbin section includes first mounting protrusions and a mounting recess, the first mounting protrusions being located in the mounting recess, and the first mounting protrusions being configured to support a grounding tab. The first bobbin section further includes a first recess. The mounting recess is formed in a bottom wall of the first recess, so that plastic material flows from the first recess to the mounting recess for plastic sealing.

In some embodiments, an end of the first recess extends to an outer periphery of the first bobbin section, and the other end of the first recess extends toward the middle of the first bobbin section.

In some embodiments, the first bobbin section further includes a guide groove. The guide groove is communicated with the first recess, and the guide groove is disposed on an outer side of the first recess, so that the plastic material flows from the guide groove to the first recess.

In some embodiments, a plurality of guide grooves are provided, and the plurality of guide grooves are arranged around the first recess.

In some embodiments, two guide grooves are provided, and the two guide grooves are respectively arranged on two opposite ends of the first recess.

In some embodiments, the depth of the guide groove gradually increases in a direction close to the first recess, and the maximum depth of the guide groove is less than or equal to the minimum depth of the first recess.

In some embodiments, the first bobbin section further includes a plurality of first limiting protrusions. at least one first limiting protrusion is disposed on a first side of the first mounting protrusion, and at least one first limiting protrusion is disposed on a second side of the first mounting protrusion which is opposite to the first side, so that plurality of first limiting protrusions limit the position of the grounding tab along the width direction of the grounding tab.

In some embodiments, a plurality of first limiting protrusions are disposed on both sides of the first mounting protrusion, and the plurality of first limiting protrusions located on one side of the first mounting protrusion are arranged at intervals in an extension direction of the grounding In some embodiments, a plurality of first mounting protrusions are provided, and the plurality of first mounting protrusions are arranged at intervals in the extension direction of the grounding tab.

In some embodiments, the first bobbin section includes an annular protrusion. The annular protrusion protrudes from an outer surface of the first bobbin section, and a second recess is formed in the annular protrusion, so that after a magnetic conductive frame is placed on the first bobbin section, the plastic material fills the second recess for plastic sealing; or one end of the first recess extends to the outer periphery of the first bobbin section, and the other end of the first recess extends to the annular protrusion; or the first bobbin section includes an annular protrusion. The annular protrusion protrudes from an outer surface of the first bobbin section, and a second recess is formed in the annular protrusion, so that after a magnetic conductive frame is placed on the first bobbin section, the plastic material fills the second recess for plastic sealing, and one end of the first recess extends to the outer periphery of the first bobbin section, and the other end of the first recess extends to the annular protrusion.

In some embodiments, the depth of the second recess is less than the depth of the first recess, so that a first step is formed between the second recess and the first recess.

In some embodiments, the bobbin structure further includes a second mounting protrusion. The second mounting protrusion is arranged in the first recess, or the second mounting protrusion is configured to enclose the first recess, so that a magnetic conductive frame is supported by the second mounting protrusion.

In some embodiments, the second mounting protrusion is an L-shaped structure formed by a first protrusion section and a second protrusion section, and a free end of the first protrusion section extends toward the first mounting protrusion.

In some embodiments, the first bobbin section further includes two second limiting protrusions. The two second limiting protrusions are respectively arranged on two opposite ends of the first recess, so that a magnetic conductive frame is limited by the two limiting protrusions.

According to another aspect of the present disclosure, an electromagnetic coil is provided, including a bobbin structure. The bobbin structure is the above bobbin structure.

Applying the technical solution of the present disclosure, the bobbin structure of the present disclosure includes the first bobbin section. The first bobbin section includes the first mounting protrusions and the mounting recess, the first mounting protrusions being located in the mounting recess, and the first mounting protrusions being configured to support the grounding tab. The first bobbin section further includes the first recess. The mounting recess is formed in the bottom wall of the first recess, so that the plastic material flows from the first recess to the mounting recess for plastic sealing. In the present disclosure, the first recess is added, and the mounting recess is formed in the bottom wall of the first recess, so that in an injection molding process, the plastic material flows from the first recess to the mounting recess and fills the first recess, thereby increasing the injection molding amount, increasing the injection molding thickness, and improving the insulation performance.

### BRIEF DESCRIPTION OF THE DRAWINGS

The drawings of the specification, which constitute a part of the present disclosure, are intended to provide a further understanding of the present disclosure, and the exemplary embodiments of the present disclosure and the description thereof are intended to explain the present disclosure and do not constitute an undue limitation on the present disclosure. In the drawings:

FIG. 1 illustrates a schematic structural diagram of an embodiment of a bobbin structure according to the present disclosure from a first perspective.

FIG. 2 illustrates a schematic structural diagram of an embodiment of a bobbin structure according to the present disclosure from a second perspective.

FIG. 3 illustrates a schematic diagram of mounting a grounding tab on a bobbin structure according to an embodiment of a bobbin structure of the present disclosure.

FIG. 4 illustrates a schematic plan of an embodiment of a bobbin structure according to the present disclosure.

FIG. 5 illustrates an assembly diagram of mounting a magnetic conductive frame and a bobbin structure according to an embodiment of an electromagnetic coil of the present disclosure.

FIG. 6 illustrates a schematic diagram of a plastic-sealed electromagnetic coil according to an embodiment of an electromagnetic coil of the present disclosure.

Herein, the above drawings include the following reference signs.
1. First bobbin section; 2. Second bobbin section; 3. Third bobbin section; 10. First recess; 100. Grounding tab; 110. Third limiting protrusion; 101. First mounting protrusion; 102. Mounting recess; 20. Guide groove; 103. First limiting protrusion; 104. Annular protrusion; 30. Second recess; 40. Second mounting protrusion; 41. First protrusion section; 42. Second protrusion section; 50. Second limiting protrusion; 200. Magnetic conductive frame.

### DETAILED DESCRIPTION OF THE EMBODIMENTS

It is to be noted that the embodiments in the present disclosure and features in the embodiments can be combined with each other without conflict. The present disclosure is described in detail below with reference to the drawings and in conjunction with the embodiments.

It is to be noted that terms used herein are only for the purpose of describing the specific implementations and not intended to limit exemplary implementations of the present disclosure. For example, singular forms, used herein, are also intended to include plural forms, unless otherwise clearly pointed out. In addition, it is also to be understood that terms “contain” and/or “include” used in the specification refer/refers to existence of features, steps, operations, apparatuses, components and/or combinations thereof.

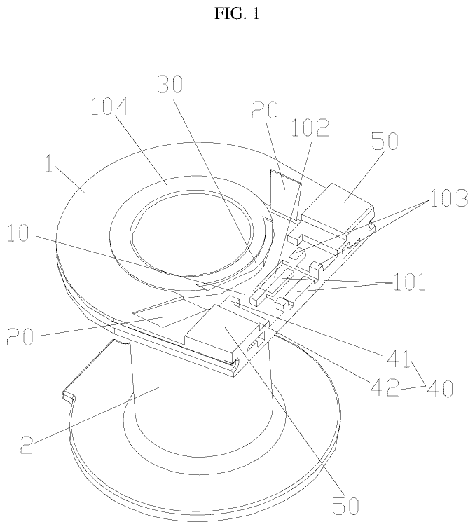

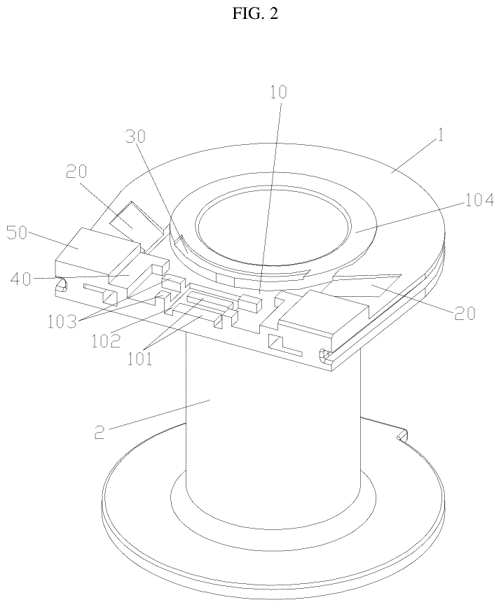

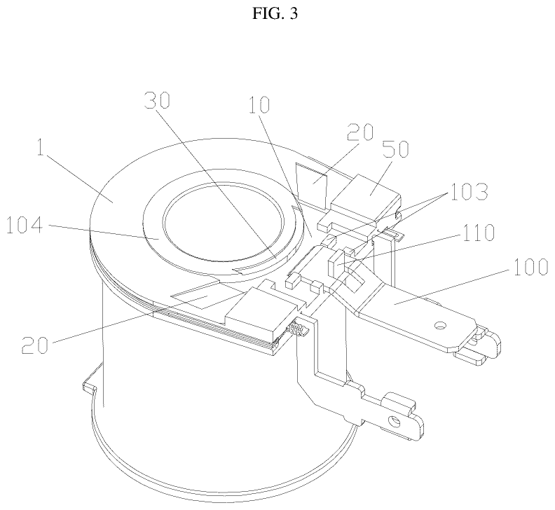

As shown in FIG. 1 to FIG. 4, the present disclosure provides a bobbin structure. The bobbin structure includes a first bobbin section 1. The first bobbin section 1 includes first mounting protrusions 101 and a mounting recess 102, the first mounting protrusions 101 being located in the mounting recess 102, and the first mounting protrusions 101 being configured to support a grounding tab 100. The first bobbin section 1 further includes a first recess 10. The mounting recess 102 is formed in a bottom wall of the first recess 10, so that plastic material flows from the first recess 10 to the mounting recess 102 for plastic sealing.

The bobbin structure of the present disclosure includes the first bobbin section 1. The first bobbin section 1 includes the first mounting protrusions 101 and the mounting recess 102, the first mounting protrusions 101 being located in the mounting recess 102, and the first mounting protrusions 101 being configured to support the grounding tab 100. The first bobbin section 1 further includes the first recess 10. The mounting recess 102 is formed in the bottom wall of the first recess 10, so that the plastic material flows from the first recess 10 to the mounting recess 102 for plastic sealing. In the present disclosure, the first recess 10 is added, and the mounting recess 102 is formed in the bottom wall of the first recess 10, so that in an injection molding process, the plastic material flows from the first recess 10 to the mounting recess 102 and fills the first recess 10, thereby increasing the injection molding amount, increasing the injection molding thickness, and improving the insulation performance.

It is to be noted that the plastic material in the present disclosure is a Bulk Molding Compound (BMC).

In some embodiments, one end of the first recess 10 extends to the outer periphery of the first bobbin section 1, and the other end of the first recess 10 extends toward the middle of the first bobbin section 1.

In some embodiments, a recess gap is formed between the first mounting protrusion 101 and the mounting recess 102.

In some embodiments, the first bobbin section 1 further includes a guide groove 20. The guide groove 20 is communicated with the first recess 10, and the guide groove 20 is arranged on an outer side of the first recess 10, so that the plastic material flows from the guide groove 20 to the first recess 10.

In some embodiments, a plurality of guide grooves 20 are provided, and the plurality of guide grooves 20 are arranged around the first recess 10.

In some embodiments, two guide grooves 20 are provided, and the two guide grooves 20 are respectively arranged on two opposite ends of the first recess 10.

Optionally, the guide grooves 20 are polygonal.

In some embodiments, the guide grooves 20 are quadrilateral, and the guide grooves 20 are of a strip-shaped structure.

In some embodiments, the depth of the guide groove 20 gradually increases in a direction close to the first recess 10, so that the plastic material may flow in a direction toward the first recess 10.

Optionally, the maximum depth of the guide groove 20 is less than the minimum depth of the first recess 10, so that a step is formed between the guide groove 20 and the first recess 10; or the maximum depth of the guide groove 20 is equal to the minimum depth of the first recess 10, so that a smooth transition is formed between the guide groove 20 and the first recess 10.

In some embodiments, the first bobbin section 1 further includes a plurality of first limiting protrusions 103. Two opposite sides of the first mounting protrusion 101 are each provided with at least one first limiting protrusion 103 to limit the grounding tab 100 in a width direction of the grounding tab 100. At least one first limiting protrusion 103 is disposed on a first side of the first mounting protrusion 101, and at least one first limiting protrusion 103 is disposed on a second side of the first mounting protrusion 101 which is opposite to the first side, so that plurality of first limiting protrusions 103 limit the position of the grounding tab 100 along the width direction of the grounding tab 100.

As shown in FIG. 1 to FIG. 3, both sides of the first mounting protrusion 101 are each provided with the plurality of first limiting protrusions 103, and the plurality of first limiting protrusions 103 located on one side of the first mounting protrusion 101 are arranged at intervals in an extension direction of the grounding tab 100.

In some embodiments, a plurality of first mounting protrusions 101 are provided, and the plurality of first mounting protrusions 101 are arranged at intervals in the extension direction of the grounding tab 100. In this way, the mounting recess 102 is formed between the two adjacent first mounting protrusions 101, so that the plastic material flows to the mounting recess 102 at the outer periphery of the first mounting protrusion 101, and also flows through the mounting recess 102 between the two adjacent first mounting protrusions 101, and the plurality of first limiting protrusions 103 are arranged at intervals in the extension direction of the grounding tab 100, so that the plastic material flows through the recess gap between the two adjacent first limiting protrusions 103, so that the amount of a plastic sealing material (BMC) of the grounding tab 100 is increased.

In some embodiments, the grounding tab 100 includes a third limiting protrusion 110. The third limiting protrusion 110 is located on one side, close to the first mounting protrusion 101, of the grounding tab 100, and the third limiting protrusion 110 is configured to limit a magnetic conductive frame 200.

In some embodiments, the first bobbin section 1 includes an annular protrusion 104. The annular protrusion 104 protrudes from an outer surface of the first bobbin section 1, and a second recess 30 is formed in the annular protrusion 104, so that after the magnetic conductive frame 200 is placed on the first bobbin section 1, the plastic material fills the second recess 30 for plastic sealing. In this way, the magnetic conductive frame 200 and the second recess 30 are fixedly connected by injection molding to prevent the magnetic conductive frame from falling off; and/or one end of the first recess 10 extends to the outer periphery of the first bobbin section 1, and the other end of the first recess 10 extends to the annular protrusion 104.

In some embodiments, the second groove 30 is of a strip-shaped structure.

In some embodiments, the depth of the second recess 30 is less than that of the first recess 10, so that a first step is formed between the second recess 30 and the first recess 10.

In some embodiments, the bobbin structure further includes second mounting protrusions 40. The second mounting protrusions 40 are arranged in the first recess 10, or the second mounting protrusions 40 are configured to enclose the first recess 10, so as to support the magnetic conductive frame 200 through the second mounting protrusions 40.

In some embodiments, the second mounting protrusion 40 is of an L-shaped structure composed of a first protrusion section 41 and a second protrusion section 42, and a free end of the first protrusion section 41 extends toward the first mounting protrusion 101.

In some embodiments, the first protrusion section 41 is configured to support the magnetic conductive frame 200, and the plastic material fills the first recess 10 between the second protrusion section 42 and the first limiting protrusion 103, so that the magnetic conductive frame 200 and the first recess 10 here are fixedly connected by injection molding, thereby further preventing the magnetic conductive frame 200 from falling off.

In some embodiments, two second mounting protrusions 40 are provided, and the two second mounting protrusions 40 are respectively arranged on the sides, away from the first mounting protrusion 101, of the first limiting protrusions 103, and the second mounting protrusions 40 and the first limiting protrusions 103 are arranged at intervals to allow the plastic material to flow through and fill the first recess 10 between the second mounting protrusions 40 and the first limiting protrusions 103.

In some embodiments, the first bobbin section further includes two second limiting protrusions 50. The two second limiting protrusions 50 are respectively arranged on two opposite ends of the first recess 10, so as to limit the magnetic conductive frame 200 through the two limiting protrusions 50.

In some embodiments, a wall surface, close to one side of the guide groove 20, of the second limiting protrusion 50 is a limiting surface, so that the magnetic conductive frame 200 is limited through the limiting surface.

In some embodiments, the guide grooves 20 and the second limiting protrusions 50 are arranged at intervals in the extension direction of the grounding tab.

In some embodiments, the second mounting protrusion 40 and the second limiting protrusion 50 are of an integrated structure.

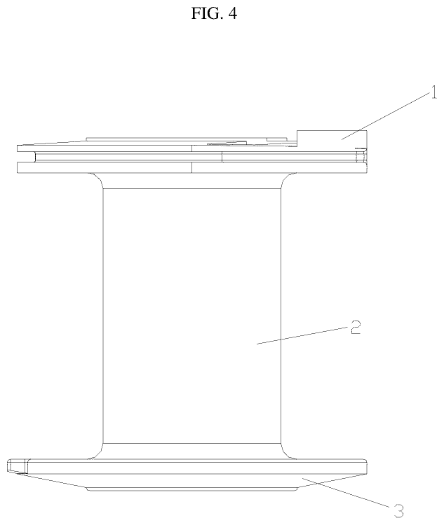

As shown in FIG. 4, the bobbin structure further includes a second bobbin section 2 and a third bobbin section 3. The first bobbin section 1 and the third bobbin section 3 are respectively arranged on both ends of the second bobbin section 2. The outer perimeter of the third bobbin section 3 gradually increases in a direction close to the first bobbin section 1. In this way, package with the plastic sealing material is facilitated.

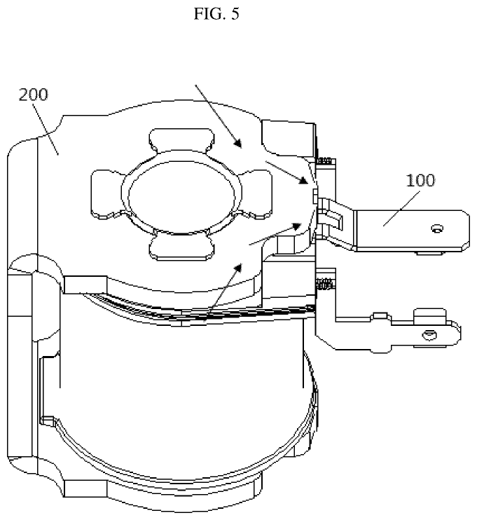

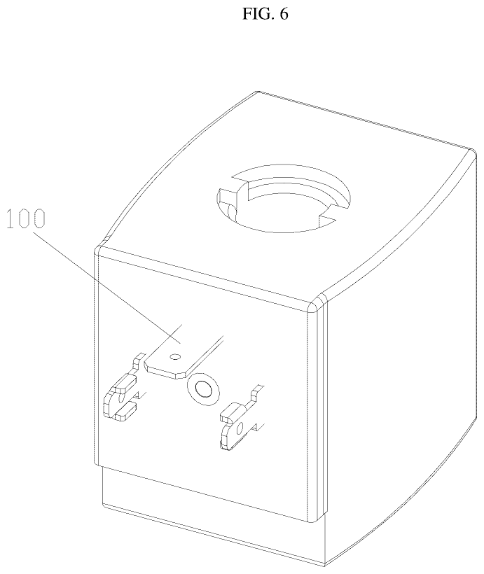

Referring to FIG. 5 and FIG. 6, the present disclosure further provides an electromagnetic coil, including a bobbin structure. The bobbin structure is the above bobbin structure. The direction of the arrow in FIG. 5 is a flow direction of a plastic material.

From the above description, it can be seen that the above embodiments of the present disclosure achieve the following technical effects.

The bobbin structure of the present disclosure includes the first bobbin section 1. The first bobbin section 1 includes the first mounting protrusions 101 and the mounting recess 102, the first mounting protrusions 101 being located in the mounting recess 102, and the first mounting protrusions 101 being configured to support the grounding tab 100. The first bobbin section 1 further includes the first recess 10. The mounting recess 102 is formed in the bottom wall of the first recess 10, so that the plastic material flows from the first recess 10 to the mounting recess 102 for plastic sealing. In the present disclosure, the first recess 10 is added, and the mounting recess 102 is formed in the bottom wall of the first recess 10, so that in an injection molding process, the plastic material flows from the first recess 10 to the mounting recess 102 and fills the first recess 10, thereby increasing the injection molding amount, increasing the injection molding thickness, and improving the insulation performance.

For ease of description, spatially relative terms such as “over”, “above”, “on an upper surface” and “upper” can be used herein for describing a spatial position relation between a device or feature and other devices or features shown in the drawings. It should be understood that the spatially relative terms are intended to contain different orientations of the device in usage or operation besides the orientations of the devices described in the drawings. For example, if the devices in the drawings are inverted, those described as “above other devices or structures” or “over other devices or structures” will then be positioned as “below other devices or structures” or “under other devices or structures”. Thus, the exemplary term “above” can include both “above” and “below” orientations. The device can also be positioned in various other ways (rotated 90 degrees or at other orientations) and the spatially relative descriptions used herein are interpreted accordingly.

Furthermore, it is to be noted that the use of the words “first”, “second” and the like to define parts is only for the convenience of distinguishing the corresponding parts, unless otherwise stated, the words have no special meaning, and therefore cannot be construed as limiting the scope of protection of the present disclosure.

The above is only the preferred embodiments of the present disclosure, and is not intended to limit the present disclosure, and for those of ordinary skill in the art, various modifications and changes can be made to the present disclosure. Any modifications, equivalent substitutions, improvements, etc. within the spirit and scope of the present disclosure shall be included in the scope of protection of the present disclosure.

What claimed is:

1. A bobbin structure, wherein the bobbin structure comprises:
a first bobbin section, comprises a first mounting protrusions and a mounting recess, the first mounting protrusions being disposed on the mounting recess, and the first mounting protrusions being configured to support a grounding tab;
the first bobbin section further comprises a first recess, the mounting recess is disposed on a bottom wall of the first recess, so that plastic material flows from the first recess to the mounting recess for plastic sealing.

2. The bobbin structure as claimed in claim 1, wherein,
an end of the first recess extends to an outer periphery of the first bobbin section, and the other end of the first recess extends toward the middle of the first bobbin section.

3. The bobbin structure as claimed in claim 1, wherein the first bobbin section further comprises a guide groove, the guide groove is communicated with the first recess, and the guide groove is disposed on an outer side of the first recess, so that the plastic material flows from the guide groove to the first recess.

4. The bobbin structure as claimed in claim 3, wherein a plurality of guide grooves are provided, and the plurality of guide grooves are disposed around the first recess.

5. The bobbin structure as claimed in claim 3, wherein two guide grooves are provided, and the two guide grooves are respectively disposed on two opposite ends of the first recess.

6. The bobbin structure as claimed in claim 3, wherein the depth of the guide groove gradually increases in a direction close to the first recess, and the maximum depth of the guide groove is less than or equal to the minimum depth of the first recess.

7. The bobbin structure as claimed in claim 1, wherein the first bobbin section further comprises a plurality of first limiting protrusions, at least one first limiting protrusion is disposed on a first side of the first mounting protrusion, and at least one first limiting protrusion is disposed on a second side of the first mounting protrusion which is opposite to the first side, so that plurality of first limiting protrusions limit the position of the grounding tab along the width direction of the grounding tab.

8. The bobbin structure as claimed in claim 7, wherein a plurality of first limiting protrusions are disposed on both sides of the first mounting protrusion, and the plurality of first limiting protrusions disposed on one side of the first mounting protrusion are disposed at intervals in an extension direction of the grounding tab.

9. The bobbin structure as claimed in claim 1, wherein a plurality of first mounting protrusions are provided, and the plurality of first mounting protrusions are disposed at intervals in an extension direction of the grounding tab.

10. The bobbin structure as claimed in claim 1, wherein the first bobbin section comprises an annular protrusion, the annular protrusion protrudes from an outer surface of the first bobbin section, and a second recess is disposed on the annular protrusion, so that after a magnetic conductive frame is placed on the first bobbin section, the plastic material fills the second recess for plastic sealing; and/or one end of the first recess extends to the outer periphery of the first bobbin section and the other end of the first recess extends to the annular protrusion; or the first bobbin section comprises an annular protrusion, the annular protrusion protrudes from an outer surface of the first bobbin section, and a second recess is disposed on the annular protrusion, so that after a magnetic conductive frame is placed on the first bobbin section, the plastic material fills the second recess for plastic sealing; and one end of the first recess extends to the outer periphery of the first bobbin section, and the other end of the first recess extends to the annular protrusion.

11. The bobbin structure as claimed in claim 10, wherein,
the depth of the second recess is less than the depth of the first recess, so that a first step is disposed between the second recess and the first recess

12. The bobbin structure as claimed in claim 1, the bobbin structure further comprises:
a second mounting protrusion, disposed on the first recess, or the second mounting protrusion is configured to enclose the first recess, so that a magnetic conductive frame is supported by the second mounting protrusion

13. The bobbin structure as claimed in claim 12, wherein the second mounting protrusion is an L-shaped structure formed by a first protrusion section and a second protrusion section, and a free end of the first protrusion section extends toward the first mounting protrusion.

14. The bobbin structure as claimed in claim 1, wherein the first bobbin section further comprises:
two second limiting protrusions, respectively disposed on two opposite ends of the first recess, so that a magnetic conductive frame is limited by the two limiting protrusions.

15. An electromagnetic coil, comprising a bobbin structure, wherein the bobbin structure is the bobbin structure as claimed in claim 1.

16. An electromagnetic coil, comprising a bobbin structure, wherein the bobbin structure is the bobbin structure as claimed in claim 2.

17. An electromagnetic coil, comprising a bobbin structure, wherein the bobbin structure is the bobbin structure as claimed in claim 3.

18. An electromagnetic coil, comprising a bobbin structure, wherein the bobbin structure is the bobbin structure as claimed in claim 4.

19. An electromagnetic coil, comprising a bobbin structure, wherein the bobbin structure is the bobbin structure as claimed in claim 5.

20. An electromagnetic coil, comprising a bobbin structure, wherein the bobbin structure is the bobbin structure as claimed in claim 6.
